(19) United States
(12) Patent Application Publication
(10) Pub. No.: US 2005/0184647 A1
(43) Pub. Date: Aug. 25, 2005

(54) Electron emission device

(76) Inventor: Cheol-Hyeon Chang, Suwon-si (KR)

Correspondence Address: CHRISTIE, PARKER & HALE, LLP, PO BOX 7068, PASADENA, CA, 91109-7068, US

(21) Appl. No.: 11/064,552

(22) Filed: Feb. 24, 2005

(30) Foreign Application Priority Data
Feb. 25, 2004 (KR) 10-2004-0012636

(51) Int. Cl. H01J 1/62

(52) U.S. Cl. 313/497

(57) ABSTRACT

An electron emission device is provided comprising first and second substrates facing each other and separated from each other by a predetermined distance. An electron emission unit is disposed on the first substrate, and an image display unit is disposed on the second substrate. A focusing electrode comprising a plurality of beam-guide holes is disposed between the first and second substrates. The portion of the focusing electrode located near a beam-guide hole comprises a thin layer. The remainder of the focusing electrode comprises a thick layer having a thickness larger than the thickness of the thin layer.

### CROSS-REFERENCE TO RELATED APPLICATION

This application claims the benefit of and priority to Korean Patent Application No. 10-2004-0012636 filed on Feb. 25, 2004 in the Korean Intellectual Property Office, the entire disclosure of which is incorporated herein by reference.

### FIELD OF THE INVENTION

The present invention relates to an electron emission device, and in particular, to a focusing electrode for an electron emission device.

### BACKGROUND OF THE INVENTION

Generally, electron emission devices are classified into two types. In the first type, a hot cathode is used as an electron emission source. In the second type, a cold cathode is used as the electron emission source.

Known electron emission devices of the second type include a field emitter array (FEA) type, a surface conduction emitter (SCE) type, a metal-insulator-metal (MIM) type, a metal-insulator-semiconductor (MIS) type, and a ballistic electron surface emitting (BSE) type.

Electron emission devices differ in specific structure depending on the type of device. However, each electron emission device basically includes an electron emission unit contained within a vacuum vessel and an image display unit facing the electron emission unit in the vacuum vessel.

In an FEA type electron emission device, electrons are emitted from the electron emission regions by electric fields formed when driving voltages are applied to the driving electrodes located in the electron emission regions.

A grid electrode is disposed between first and second substrates which form a vacuum vessel. The grid electrode comprises a mesh-shaped metallic plate having a plurality of beam-guide holes spaced apart from each other by a predetermined distance. The grid electrode increases the ability to focus the electron beams emitted from the electron emission regions, enhances color purity, and enhances the withstand-voltage characteristics of the cathode and anode electrodes. Alternatively, a focusing electrode having a structure different from that of the grid electrode may be positioned between the first and second substrates.

Whether a grid electrode or focusing electrode is used, increases in the focusing capacity of the electron beam negatively affect the withstand-voltage characteristic, i.e. the capacity to intercept electric fields emanating from the anode electrode. Similarly, improvements in the withstand-voltage characteristic negatively affect the focusing capacity of the electron beam. Specifically, in contrast to the cathode electrode, when a negative voltage is applied to the focusing electrode to heighten the focusing capacity, the number of electrons landing on the anode electrode is significantly reduced, thereby decreasing brightness. In order to enhance brightness while applying a negative voltage to the focusing electrode, either the distance between the focusing electrode and the electron emission region, or the thickness of the focusing electrode is increased. However, when this is done, the focusing capacity is reduced and the electric field of the anode electrode reaches the electron emission regions directly. Consequently, a high voltage cannot be applied to the anode electrode, resulting in reduced brightness.

Due to the above problems, when negative voltage is applied to the focusing electrode, the focusing capacity is enhanced, but brightness is reduced. Specifically, the focusing electrode cuts off the current from the anode electrode, thereby preventing the flow of a sufficient anode current. Consequently, a high anode voltage cannot be applied, and brightness is reduced. As a metallic layer is not formed on the phosphor layers, the life span and efficiency of the phosphors are decreased.

When a grid electrode comprising a metal mesh is used to intercept intense anode current, it is easy to apply a high voltage to the anode electrode. However, when a negative voltage is applied to the grid electrode, most of the electrons emitted from the cathode electrode are also intercepted due to the thickness of the grid electrode, and the number of electrons landing on the anode electrode is radically reduced. When a positive voltage is applied to the grid electrode, beam spreading cannot focus the electron beams, resulting in significantly reduced color representation.

Accordingly, use of an anode interception electrode in addition to the focusing electrode has been proposed. However, in such a configuration, an insulating layer is placed between the focusing electrode and the anode interception electrode. Such an insulating layer exerts a negative influence on the other electrode layers during developing and etching. Furthermore, the processing steps for such a configuration are extremely complicated and involve increased production costs and reduced production yield.

### SUMMARY OF THE INVENTION

In accordance with the present invention, an electron emission device is provided which improves the structure of the focusing electrode to obtain sufficient beam focusing capacity, and enhance brightness and color representation.

The inventive electron emission device includes first and second substrates facing each other and separated from each other by a predetermined distance. An electron emission unit is located on the first substrate and an image display unit is located on the second substrate. A focusing electrode having a plurality of beam-guide holes is located between the first and second substrates. Near the beam-guide holes, the thickness of the focusing electrode is thin. The thickness of the remainder of the focusing electrode is thick, having a thickness greater than that of the thickness near the beam-guide holes.

The thickness of the focusing electrode may be stepped near the beam-guide holes. Alternatively, the focusing electrode may comprise a thick layer formed over a thin layer except that the thick layer is omitted from regions near the beam-guide holes. In another embodiment, the regions of the focusing electrode near the beam-guide holes comprises a thin layer, and the remainder of the focusing electrode comprises a thick layer electrically connected to the thin layer.

The thin layer may be applied on the focusing electrode by deposition, and the thick layer may be applied on the focusing electrode by screen printing of a conductive metal paste. Alternatively, the thin layer and the thick layer may comprise the same conductive material.

The thin layer may be ring-shaped having a predetermined width and extend along the edge of each beam-guide hole.

The focusing electrode may be applied by first applying the thick layer, and then applying the thin layer.

In an alternative embodiment, a plurality of focusing electrodes are positioned on the electron emission unit.

The focusing electrode may comprise a metallic material.

The electron emission unit on the first substrate comprises a plurality of cathode electrodes arranged on the first substrate and spaced apart by a predetermined distance. Electron emission regions are disposed on the cathode electrodes. Each electron emission region may comprise a carbonaceous material or a nano-sized material. An insulating layer is disposed over the cathode electrodes, and a plurality of gate electrodes are disposed over the insulating layer.

The image display unit on the second substrate comprises an anode electrode positioned on the second substrate, and a plurality of phosphor layers positioned in a predetermined pattern on the anode electrode.

### BRIEF DESCRIPTION OF THE DRAWINGS

The above and other advantages of the present invention will be better understood by reference to the following detailed description when considered in conjunction with the accompanying drawings wherein:

FIG. 1 is a partial perspective view of an electron emission device according to a first embodiment of the present invention;

FIG. 2 is a partial cross-sectional view of the electron emission device according to FIG. 1;

FIG. 3 is a partial perspective view of an electron emission region of an electron emission device according to a second embodiment of the present invention;

FIG. 4 is a partial perspective view of a focusing electrode of an electron emission device according to a third embodiment of the present invention; and

FIG. 5 is a partial perspective view of a focusing electrode of an electron emission device according to a fourth embodiment of the present invention.

### DETAILED DESCRIPTION OF THE EMBODIMENTS

The present invention will be described more fully hereinafter with reference to the accompanying drawings, in which preferred embodiments of the invention are shown.

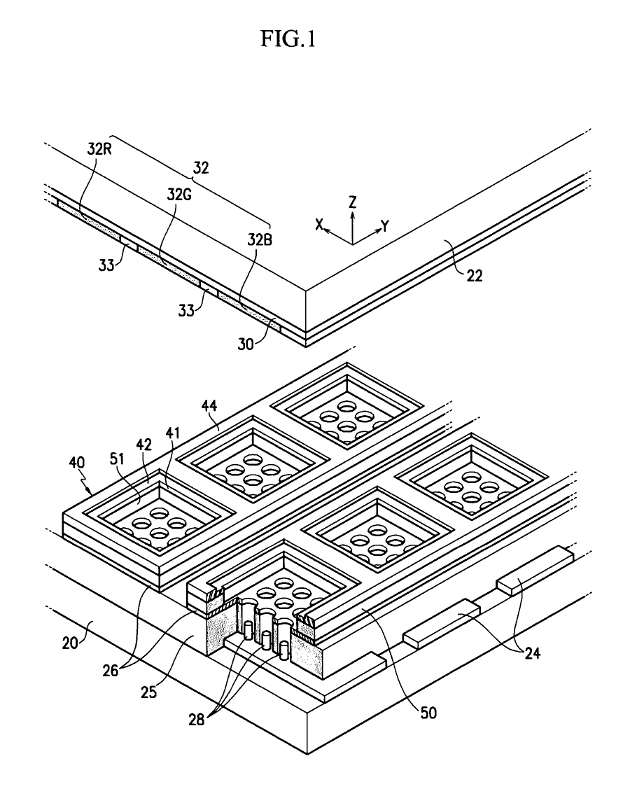

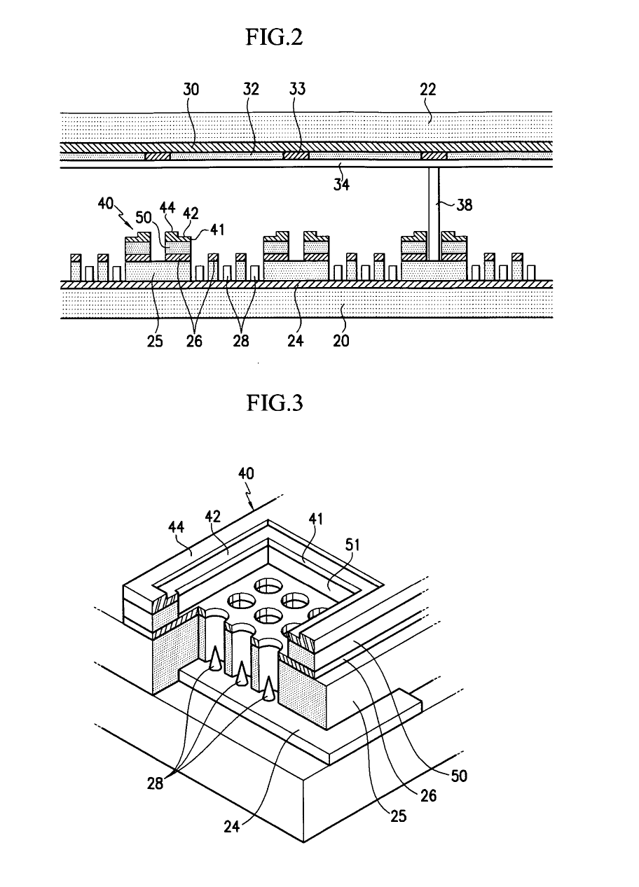

As shown in FIGS. 1 and 2, an electron emission device according to a first embodiment of the present invention includes first and second substrates 20 and 22, respectively, positioned facing each other and separated from each other by a predetermined distance, thereby forming a vacuum vessel.

An electron emission unit is provided on the first substrate 20, and an image display unit is provided on the second substrate 22. The electron emission unit emits electrons to the image display unit, which thereby emits light, displaying the desired images.

The electron emission unit on the first substrate 20 comprises a plurality of cathode electrodes 24 arranged on the first substrate 20 and spaced apart by a predetermined distance. Electron emission regions 28 are positioned on the cathode electrodes 24. A plurality of gate electrodes 26 are positioned over the cathode electrodes 24 and extend perpendicular to the cathode electrodes 24. An insulating layer 25 is positioned between the cathode electrodes 24 and the gate electrodes 26.

The image display unit on the second substrate comprises an anode electrode 30 positioned on the second substrate 22 and a plurality of phosphor layers 32 positioned in a predetermined pattern on the anode electrode 30.

A second insulating layer 50 is positioned over the gate electrodes 26, and a plurality of focusing electrodes 40 are positioned over the second insulating layer 50 between the first and second substrates 20 and 22, respectively. Each focusing electrode 40 comprises a plurality of beam-guide holes 41. Each focusing electrode 40 comprises a thin layer 42 and a thick layer 44. The thick layer 44 has a thickness larger than that of the thin layer 42.

In this embodiment, a plurality of focusing electrodes 40 are arranged on the first substrate 20 in a pattern corresponding to the pattern of the gate electrodes 26. The beam-guide holes 41 of the focusing electrodes 40 are arranged in a predetermined pattern corresponding to the pattern of the electron emission regions 28.

The focusing electrodes 40 increase the ability to focus the electron beams emitted from the electron emission regions 28. The focusing electrodes may comprise thin metallic sheets, each having a plurality of beam-guide holes 41 spaced apart by a predetermined distance. Such a configuration creates a metal mesh.

The gate electrodes 26 and cathode electrodes 24 are positioned in a striped pattern and extend perpendicular to each other. Specifically, as shown in FIG. 1, the cathode electrodes 24 are arranged in a striped pattern extending along the Y axis, and the gate electrodes 26 are arranged in a striped pattern extending along the X axis. An insulating layer 25 is disposed between the gate electrodes 26 and cathode electrodes 24 and covers the entire surface of the first substrate 20. The electron emission regions 28 are located at the points of intersection of the gate electrodes 26 and cathode electrodes 24, and are electrically connected to the cathode electrodes 24.

The electron emission regions 28 are flat emitters having a substantially even thickness. Each electron emission region 28 comprises a carbonaceous material that emits electrons well under low voltage driving conditions, i.e. a voltage of about 10 to about 100 V. The carbonaceous material may be selected from the group consisting of graphite, diamond, diamond-like carbon, carbon nanotubes, C₆₀ (fullerene), and combinations thereof. Among these carbonaceous materials, carbon nanotubes are preferable because they have a very small terminal curvature radius of several to several tens of nanometers, and they emit electrons well even in a low voltage electric field, e.g. about 1 to about 10 V/μm. Alternatively, the electron emission regions 28 may comprise nanometer-sized materials, such as nanotubes, graphite nanofiber, or silicon nanowire.

As shown in FIG. 3, the electron emission regions 28 may take the shape of a cone.

Alternatively, the electron emission regions 28 may take various other shapes, such as a wedge or a thin edged film.

The gate electrodes 26 and the insulating layer 25 include holes to allow placement of the electron emission regions 28 on the cathode electrodes 24 and to enable electron emission to the second substrate 22.

The anode electrode 30 is disposed on the second substrate 22 and comprises a transparent electrode material, such as indium tin oxide (ITO), which exhibits excellent light transmittance.

As shown in FIG. 1, the phosphor layers 32 are disposed on the second substrate 22 such that red, green, and blue phosphor layers 32R, 32G, and 32B, respectively, are arranged in alternating sequence and are spaced apart from each other by a predetermined distance. The phosphor layers 32R, 32G and 32B extend along the same direction as the focusing electrodes 40, i.e. the direction of the X axis. Dark layers 33 are positioned between the phosphor layers 32R, 32G, and 32B to enhance contrast.

As shown in FIG. 2, a thin metallic layer 34 may be positioned over the phosphor layers 32 and dark layers 33. The metallic layer 34 may comprise aluminum. The thin metallic layer 34 enhances withstand-voltage and brightness characteristics.

Alternatively, the phosphor layers 32 and the dark layers 33 are disposed directly on the second substrate 22, omitting the transparent anode electrode 30, and the thin metallic layer 34 is disposed over the phospor layers 32 and dark layers 33. In such a configuration, the metallic layer 34 functions as an anode electrode under high voltage. In this embodiment, screen brightness is enhanced more effectively than it is when the anode electrode 30 is positioned on the second substrate 22 and comprises a transparent electrode material.

The first and second substrates 20 and 22, respectively, are separated from each other by a predetermined distance and are sealed together by a sealant. The first and second substrates 20 and 22, respectively, are sealed together such that the cathode electrodes 24 and phosphor layers 32 are positioned perpendicular to each other. The inner space between the two substrates 20 and 22 is then evacuated, and the sealed structure is kept in a vacuum state.

In order to retain a constant distance between the first and second substrates 20 and 22, respectively, spacers 38 are positioned between the first and second substrates 20 and 22, respectively, and are separated from each other by a predetermined distance. Preferably, the spacers 38 are positioned to avoid pixel locations and electron beam routes.

An insulating layer 50 for electrical insulation is disposed between the focusing electrodes 40 and gate electrodes 26. The insulating layer 50 comprises beam-guide holes 51 corresponding in size and location to the beam-guide holes 41 of the focusing electrodes 40.

In one embodiment, the portion of each focusing electrode 40 located near the edge of a beam-guide hole 41 comprises a thin layer 42. Specifically, as shown in FIGS. 1 and 2, the portion of each focusing electrode 40 located near a beam-guide hole 41 comprises a thin layer 42, while the remainder of the focusing electrode comprises a thick layer 44, thereby creating a focusing electrode 40 that is stepped around the edges of each beam-guide hole 41.

Alternatively, a thick layer 44 is first deposited over the entire surface of each focusing electrode 40. The portion of each focusing electrode 40 located near each beam-guide hole 41 is then processed, e.g. by partial or half etching, to form a thin layer 42 around the edges of each beam-guide hole 41.

In another alternative embodiment, each focusing electrode 40 comprises a metal mesh. The portion of the metal mesh located near each beam-guide hole 41 is processed, e.g. by partial or half etching, resulting in a thin layer around the edges of each beam-guide hole 41.

Because the electric field is applied at the edges of the thin layer 42 located near each beam-guide hole 41, sufficient beam focusing capacity is obtained.

Where desired, the thick layer 44 can comprise a multi-stepped structure.

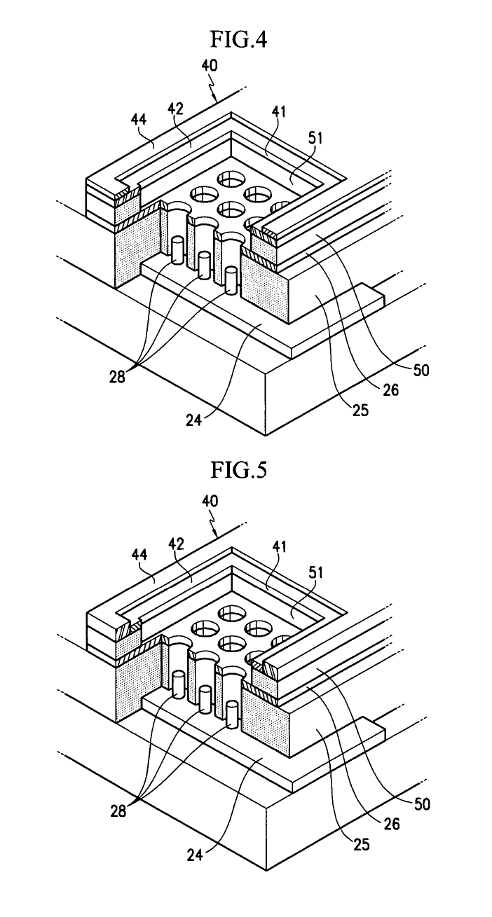

In an alternative embodiment, as shown in FIG. 4, each focusing electrode 40 comprises a thin layer 42 disposed on the insulating layer 50 and a thick layer 44 disposed on the thin layer 42 and spaced apart from each beam-guide hole by a predetermined distance.

The thin layer 42 is preferably applied by deposition, and the thick layer by screen printing of a conductive metal paste.

The conductive metallic material for forming the thick layer 44 is selected from the group consisting of silver (Ag), gold (Au), platinum (Pt), palladium (Pd), copper (Cu), nickel (Ni), aluminum (Al), tungsten (W), molybdenum (Mo), molybdenum/tungsten (Mo/W), molybdenum/manganese (Mo/Mn), lead (Pb), tin (Sn), chromium (Cr), chromium/aluminum (Cr/Al), and combinations thereof. The conductive metallic material for forming the thick layer 44 contains small particles having diameters of several micrometers or less.

The thin layer 42 may be applied by deposition of ITO, aluminum (Al), chromium (Cr), or chromium/aluminum (Cr/Al), and combinations thereof.

In an alternative embodiment, as shown in FIG. 5, the portion of each focusing electrode 40 located near a beam-guide hole 41 comprises a thin layer 42 extending along the edges of the beam-guide hole 41. The remainder of each focusing electrode 40, i.e. the portion located on the outer edges of the thin layer 42, comprises a thick layer 44. The thin layer 42 of each focusing electrode 40 has a predetermined width and takes a ring or band shape such that it extends along the edges of the beam-guide hole 41. The thin and thick layers 42 and 44, respectively, are electrically connected to each other. The portion of the thin layer 42 located near the beam-guide hole 41 surrounds the beam-guide hole 41, and the thick layer 44 surrounds the thin layer 42.

Such a configuration of the focusing electrode 40, namely, a focusing electrode having a portion located near the beam-guide hole 41 comprising a thin layer 42 and the remaining portion comprising a thick layer 44, prevents the formation of a crack which is sometimes generated when the thin layer 42 is applied before the thick layer 44. Such a crack is generated due to the stress applied to the thin layer 42 during the thermal processing required for later application of the thick layer 44. This crack may also be prevented by first applying the thick layer 44, and then applying the thin layer 42.

The thin layer 42 and thick layer 44 may comprise the same conductive material, or may comprise different materials.

The thick layer 44 prevents the electric field generated when voltage is applied to the anode electrode 32 from affecting the electron emission regions 28. The thin layer 42 enables sufficient electron beam focusing capacity.

Furthermore, the thin and thick layers 42 and 44, respectively, of the focusing electrode simultaneously enhance beam focusing capacity and brightness. Specifically, the thin layer of the focusing electrode generates an electric field for focusing electron beams. Therefore, in contrast to the cathode electrodes, when a negative voltage is applied to the focusing electrode, the number of electrons passing through the beam-guide holes is not significantly reduced, thereby enhancing brightness, beam focusing capacity, and color representation.

Also, because the thick layer of the focusing electrode does not generate an electric field, when high voltage is applied to the anode electrode, the anode electric field is intercepted before reaching the electron emission regions in a stable and constant manner, thereby enabling application of high voltage to the anode electrode while enhancing brightness and display quality.

The thick layer 44 of the focusing electrode enables application of high voltage to the anode electrode as well as formation of a thin metallic layer on the phosphor layers, which increases the life span and light emission efficiency of the phosphors in the phosphor layers.

The inventive electron emission device reduces the formation of insulating layers and electrodes by half, as compared to conventional processes for forming a focusing electrode and an anode interception electrode. Specifically, the inventive electron emission device involves simplified processing steps, enhanced production yield, and decreased production cost.

Although preferred embodiments of the present invention have been described in detail above, it should be clearly understood that many variations and/or modifications of the basic inventive concept which may appear to those skilled in the art also fall within the spirit and scope of the present invention, as defined in the appended claims.

1. An electron emission device comprising:
first and second substrates facing each other and separated from each other by a predetermined distance;
an electron emission unit disposed on the first substrate;
an image display unit disposed on the second substrate; and
at least one focusing electrode disposed between the first and second substrates, the focusing electrode comprising a plurality of beam-guide holes, wherein the portion of the focusing electrode located near each beam-guide hole comprises a thin layer having a first thickness, and the remainder of the focusing electrode comprises a thick layer having a second thickness, wherein the second thickness is greater than the first thickness.

2. The electron emission device of claim 1, wherein the portion of the focusing electrode near each beam-guide hole is stepped.

3. The electron emission device of claim 1, wherein the focusing electrode comprises a thin layer disposed over the entire surface of the focusing electrode and a thick layer disposed over the thin layer, wherein the thick layer is removed from the portion of the focusing electrode located near each beam-guide hole.

4. The electron emission device of claim 1, wherein the portion of the focusing electrode located near each beam-guide hole comprises a thin layer, and the remainder of the focusing electrode comprises a thick layer electrically connected to the thin layer.

5. The electron emission device of claim 3, wherein the thin layer is applied by deposition, and the thick layer is applied by screen printing of a conductive metal paste.

6. The electron emission device of claim 4, wherein the thin layer is applied by deposition, and the thick layer is applied by screen printing of a conductive metal paste.

7. The electron emission device of claim 3, wherein the thin layer and thick layer comprise the same conductive material.

8. The electron emission device of claim 4, wherein the thin layer and thick layer comprise the same conductive material.

9. The electron emission device of claim 4, wherein the thin layer is ring-shaped having a predetermined width and extending along an edge of each beam-guide hole.

10. The electron emission device of claim 4, wherein the focusing electrode is applied by first applying the thick layer, and then applying the thin layer.

11. The electron emission device of claim 1, wherein a plurality of focusing electrodes are positioned on the electron emission unit.

12. The electron emission device of claim 1, wherein the focusing electrode comprises a metallic material.

13. The electron emission device of claim 1, wherein the electron emission unit comprises:
a plurality of cathode electrodes disposed on the first substrate and spaced apart by a predetermined distance;
a plurality of electron emission regions disposed on the cathode electrodes;
an insulating layer disposed on the cathode electrodes; and
a plurality of gate electrodes disposed on the insulating layer.

14. The electron emission device of claim 13, wherein each electron emission region comprises a material selected from the group consisting of carbonaceous material and nano-sized material.

15. The electron emission device of claim 1, wherein the image display unit comprises an anode electrode disposed on the second substrate, and a plurality of phosphor layers disposed in a predetermined pattern on the anode electrode.

16. The electron emission device of claim 1, wherein the focusing electrode comprises a metal mesh.

17. The electron emission device of claim 1, wherein the thick layer of the focusing electrode comprises a material selected from the group consisting of Ag, Au, Pt, Pd, Cu, Ni, Al, W, Mo, Mo/W, Mo/Mn, Pb, Sn, Cr, Cr/Al, and combinations thereof.

18. The electron emission device of claim 1, wherein the thin layer of the focusing electrode comprises a material selected from the group consisting of indium tin oxide (ITO), Al, Cr and Cr/Al, and combinations thereof.
